(19) United States
(12) Patent Application Publication
(10) Pub. No.: US 2026/0363199 A1
(43) Pub. Date: Nov. 19, 2026

(54) PET CONTAINMENT SYSTEM FOR A VEHICLE

(71) Applicant: JANI INTERNATIONAL PTE. LTD., Singapore (SG)

(72) Inventors: Clyde S. HARMES, Morgantown, PA (US); Patrick J G BOWERS, Morgantown, PA (US); Curtis M. HARTENSTINE, Morgantown, PA (US); Joshua FERGUSON, Morgantown, PA (US)

(73) Assignee: JANI INTERNATIONAL PTE. LTD., Singapore (SG)

(21) Appl. No.: 19/153,761

(22) PCT Filed: Feb. 5, 2024
(86) PCT No.: PCT/US2024/014388

§ 371 Date: Aug. 5, 2025

Related U.S. Application Data
(60) Provisional application No. 63/443,807, filed on Feb. 7, 2023.

(51) Int. Cl. A01K 1/02; B60R 22/10

(52) U.S. Cl. CPC A01K 1/0272; B60R 22/10

(57) ABSTRACT

A pet containment system includes a containment structure for containing a pet. The containment structure is mountable in a vehicle using the vehicle's LATCH (Lower Anchors and Tethers for Children) Restraint System, or other suitable vehicle anchor point(s). The system can include a vertical and horizontally adjustable tether for securing a pet or an animal wearing a wearable such as a chest harness or a vest, and a barrier surrounding the pet or animal. The system according to the present disclosure secures the pet or the animal in the vehicle to prevent or reduce the likelihood of the pet from being impacted or injured by a sudden change in vehicle speed and/or direction.

### CROSS REFERENCE TO RELATED APPLICATION

This application claims the benefit of U.S. Provisional Patent Application No. 63/443,807, filed on Feb. 7, 2023, which is incorporated by reference as if fully set forth.

### TECHNICAL FIELD

The present disclosure relates generally to a pet containment system. In particular, the present disclosure relates to a pet containment system for securing a pet or an animal in a vehicle.

### BACKGROUND

Many people regard their pets as family members or companions. As such, pet owners often travel with their pets via automobile to vacation destinations, trips to the veterinarian, or around town. Pet transport cages or pet vests are available that cooperate with safety belts of a vehicle to prevent a pet from roaming within and/or escaping from a vehicle. However, these devices generally do not adequately secure a pet in the case of a sudden change in vehicle speed or direction, and can be difficult to install in a vehicle. An improperly restrained pet is more likely to be injured and to injure occupants of a vehicle during a crash.

### SUMMARY

In accordance with one aspect of the present disclosure an adjustable pet tether system for a vehicle comprises a base for receiving a pet, a support frame secured to the base, the support frame being removably securable to the vehicle, a carriage supported on the support frame for vertical movement along the support frame between a first lower position and a second upper position, and a tether having a free end extending from the carriage. A vertical point of attachment of the tether relative to the support frame can be adjusted by moving the carriage along the support frame to a desired vertical height.

In accordance with another aspect of the present disclosure, a pet containment system for a vehicle comprises a support frame mountable to the vehicle, a containment structure secured to the support frame for receiving for receiving a pet, and at least one latch rigidly fixed to the support frame for securing the pet containment system to a cooperating anchor of the vehicle.

In accordance with yet another aspect of the present disclosure, a pet containment system for a vehicle comprises a support frame including a upwardly extending tower portion and a horizontally extending base support portion, at least one latch rigidly fixed to the support frame for securing the pet containment system to a cooperating anchor of the vehicle, the at least one latch movable between a stowed position and a deployed position, a base secured to the base support portion of the support frame and extending outwardly from the tower portion of the support frame, the base defining at least a portion of a receptacle for receiving a pet, a collapsible boom pivotally secured at one end to the tower portion of the support frame in spaced relation to the base, the boom extending over at least a portion of the base, a flexible barrier extending between at least a portion of a perimeter of the base and the boom, a carriage supported on the tower for movement between a first lower position and a second upper position, the carriage including a tether slot, and an adjustable length tether secured to the tower portion of the support frame with a cam buckle for adjusting a length of a free end of the tether, the free end of the tether passing through the tether slot of the carriage. A vertical position of the free end of the tether can be adjusted by movement of the carriage between the first lower position and the second upper position, and a horizontal position of a terminal end of the free end of the tether can be adjusted with the cam buckle.

In accordance with still another aspect of the present disclosure, a pet containment system for a vehicle comprises a support frame including an upwardly extending tower portion and a horizontally extending base support portion, a base secured to the support frame and extending outwardly from the tower portion of the support frame, the base defining at least a portion of a receptacle for receiving a pet, a collapsible boom pivotally secured at one end to the tower portion of the support frame in spaced relation to the base, the boom extending over at least a portion of the base, and a flexible barrier extending between at least a portion of a perimeter of the base and the boom. The at least one of the support frame or the base is securable to a restraint system of a vehicle.

In accordance with still yet another aspect of the present disclosure, a method of securing a pet to a pet containment system method comprises positioning a pet in a pet containment system having a base for receiving the pet, a support frame secured to the base, the support frame being removably securable to a vehicle, a carriage supported on the support frame for vertical movement along the support frame between a first lower position and a second upper position, and a tether secured to the carriage, adjusting a vertical point of attachment of the tether relative to the support frame by moving the carriage along the support frame to a desired vertical height, and securing a free end of the tether to a wearable component worn by the pet. The method can include adjusting a length of the free end of the tether, and/or partially collapsing a collapsible boom pivotally secured at one end to a tower portion of the support frame in spaced relation to the base, the boom extending over at least a portion of the base and supporting a flexible barrier secured to the base.

In accordance with another aspect, a pet containment system for a vehicle comprises a base for receiving a pet, a support frame secured to the base, the support frame being removably securable to the vehicle, and a carriage supported on the support frame for vertical movement along the support frame between a first lower position and a second upper position, the carriage defining an attachment point for securing a pet. The carriage is movable to adjust a vertical height of the attachment point.

### BRIEF DESCRIPTION OF THE DRAWINGS

The following description of the illustrative embodiments may be better understood when read in conjunction with the appended drawings. It is understood that potential embodiments of the disclosed systems are not limited to those depicted.

FIG. 1 is a perspective view of an exemplary pet containment system according to one embodiment of the present disclosure.

FIG. 2 is a perspective view of the pet containment system of FIG. 1 with a flexible barrier and collapsible boom removed for illustrative purposes.

FIG. 3 is a perspective view of a support frame of the pet containment system of FIG. 1.

FIG. 4 is another perspective view of the pet containment system of FIG. 1 with the flexible barrier removed.

FIG. 5 is a rear perspective view of an upper portion of the pet containment system of FIG. 1.

FIG. 6 is a perspective view of an adjustable tether assembly of the pet containment system of FIG. 1.

FIG. 7 is a side elevation view of the adjustable tether assembly of FIG. 6.

FIG. 8 is a perspective view of a carriage and locking mechanisms of the adjustable tether assembly of FIG. 6.

FIG. 9 is a perspective view of a bottom side of the pet containment system of FIG. 1.

FIG. 10 is a cutaway view of the pet containment system of FIG. 1 showing a latch in a first position.

FIG. 11 is a cutaway view of the pet containment system of FIG. 1 showing a latch in a second position.

FIG. 12 is an enlarged portion of FIG. 10.

### DETAILED DESCRIPTION

The present disclosure sets forth various aspects of a pet containment system for a vehicle including a containment structure for containing a pet. The pet containment system is mountable in a vehicle using the vehicle's LATCH (Lower Anchors and Tethers for Children) Restraint System, or other suitable vehicle anchor point(s). The pet containment system includes a base, a barrier surrounding the pet or animal, a vertically and horizontally adjustable tether for securing a pet or an animal, such as by securing to a pet wearing a wearable such as a chest harness or a vest. The pet containment system according to the present disclosure secures the pet or the animal in the vehicle to prevent or reduce the likelihood of the pet from being impacted or injured by a sudden change in vehicle speed and/or direction or upon impact.

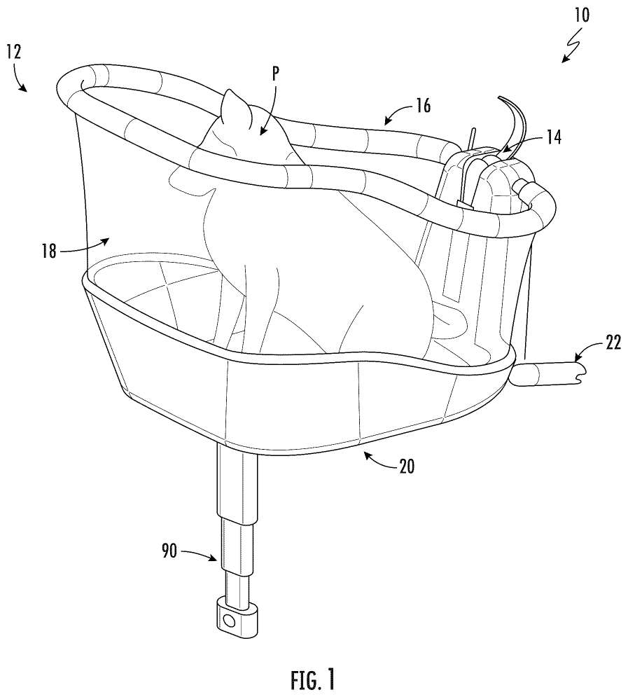

With reference to FIG. 1, the pet containment system 10 according to the present disclosure includes a containment structure 12 and a vertically and horizontally adjustable tether assembly 14. The pet containment structure 12 includes a collapsible boom 16 that supports a flexible barrier 18 extending between a base 20 and the collapsible boom 16. As will become apparent in the following description, the pet containment system 10 is configured to be secured to a vehicle with latches 22. In a typical installation, the pet containment system 10 is at least partially supported on a seat of a vehicle and the latches 22 are secured to LATCH anchors of the vehicle, which are typically located between the vehicle's seat back and seat base cushion. Once secured, a pet P is then positioned within the containment structure 12 and secured to the adjustable tether assembly 14. As will be described below, both the containment structure 12 and the adjustable tether assembly 14 have features that simplify use and allow the pet containment system 10 to be tailored for pets of various sizes.

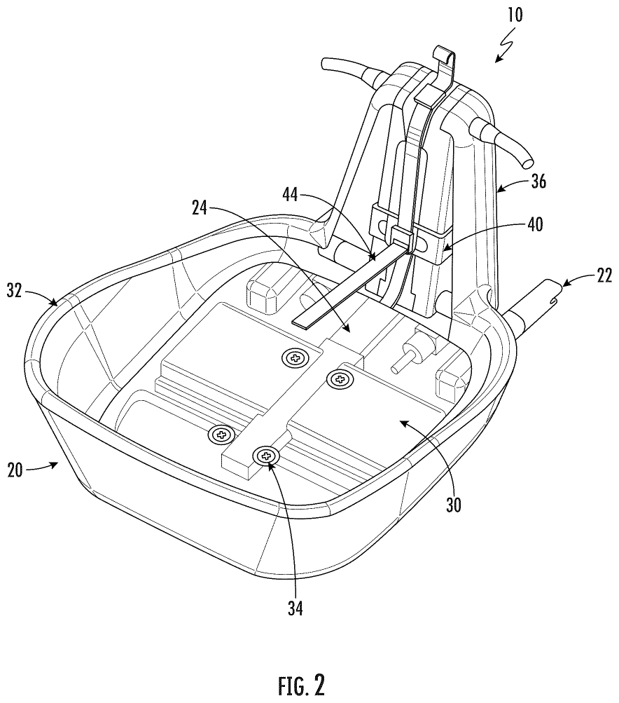

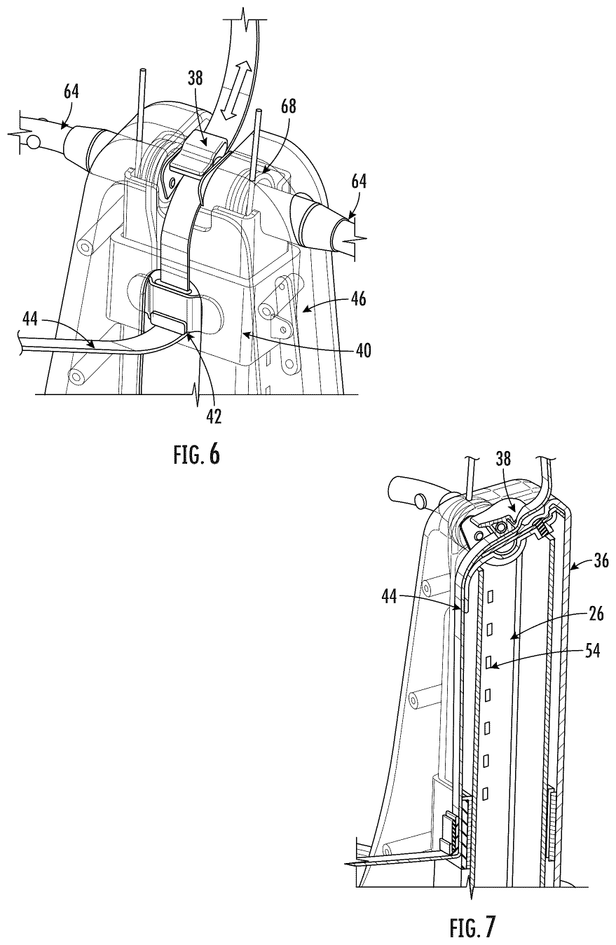

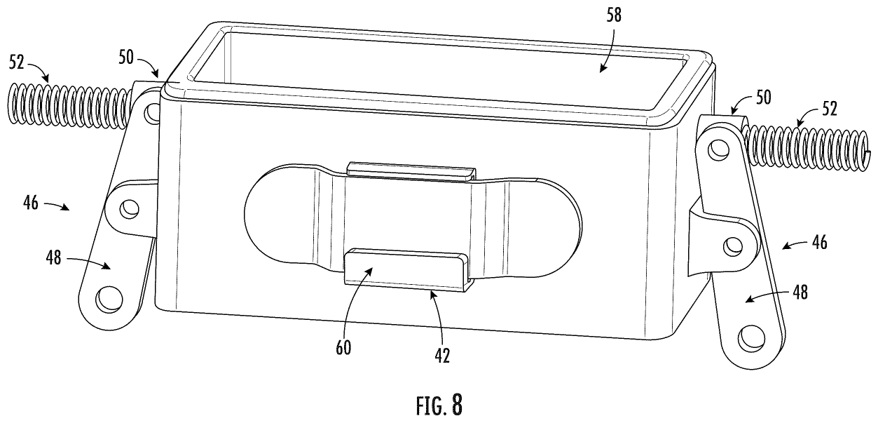

With additional reference to FIGS. 2-7, the pet containment system 10 includes a support frame 24 having an upstanding tower portion (or rail) 26 and a horizontally extending base support portion 28 to which the base 20 of the containment structure 12 is mounted. The base 20 includes a bottom wall 30 and an upwardly extending perimeter wall 32. The bottom wall 30 of the base 20 is secured to the base support portion 28 of the support frame 24, for example, and without limitation, with a plurality of fasteners 34, such as screws, bolts, rivets or the like. Extending upwardly from the base 20 is a shroud 36 adapted to at least partially enclose the tower 26 of the support frame 24 and related components. The shroud 36 can be formed integrally with the base 20 or can be a separate component. The support frame 24 is typically made of a material such as steel or aluminum. The support frame 24 can be made of a unitary, single piece of material such as in a stamping process. More typically, the support frame 24 is comprised of at least two pieces joined together, for example, by a welding process. The base 20 and shroud 36 are typically made of a plastic material. It will be appreciated, however, that a wide variety of materials can be used for the various components of the present disclosure.

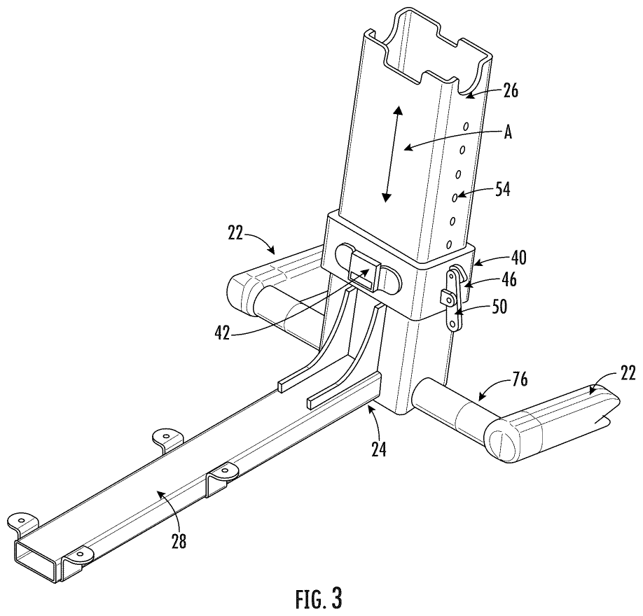

The tower portion 26 of the support frame 24 supports the adjustable tether assembly 14. The adjustable tether assembly 14 generally includes a cam buckle 38 secured to the tower portion 26 of the support frame 24, and a carriage 40 mounted to the tower portion 26 for reciprocal sliding movement in the directions indicated by arrow A in FIG. 3. The carriage 40 includes a tether slot 42 through which a tether 44 is threaded for connection to a pet or animal, for example, through a vest or harness of a pet. Slot 42 can be considered a point of attachment of the tether to the carriage 40 because the bounds of the slot 42 constrain the tether 44. It should be appreciated that the carriage 40 could alternatively include structure for attachment of a tether or leash directly to the carriage 40. Such structure can include a d-ring or the like.

The cam buckle 38 facilitates adjustment of the length of the free end of the tether 44 and, accordingly, a horizontal position of a terminal end of the free end of the tether 44 within the containment structure 12. The cam buckle 38 is just one of many adjustment mechanisms that can be employed for releasably securing the tether at various lengths without departing from the scope of the present disclosure. Movement of the carriage 40 along the tower portion 26 adjusts a vertical position of the free end of the tether 44. One or more release mechanisms 46 supported on the carriage 40 are configured to selectively lock the carriage in a desired vertical position along the tower portion 26. As used herein, the free end of the tether 44 refers to the portion of the tether 44 extending from the slot 42 for connection to a harness or vest or other wearable of a pet.

With additional reference to FIG. 8, an enlarged view of the carriage 40 is shown including release mechanisms 46. Each release mechanism 46 generally includes an actuator bar 48 supported by the carriage 40 for pivoting movement at a central portion thereof. A first end of the actuator bar 48 is attached to a lock pin 50 supported for reciprocating movement by the carriage 40 between a locked position (as shown in FIG. 8) and a release position (not shown). The lock pins 50 are biased towards the locked position by springs 52. The lock pins 50 are adapted to be received in one of a plurality of height adjustment holes 54 (see FIG. 3, for example) in the tower portion 26 when in the locked position. The release position of the lock pins 50 is achieved when second ends of the actuator bars 48 are moved towards each other in FIG. 8 causing the first ends of the actuator bars 48 to move away from each other thereby withdrawing the lock pins 50 from a respective hole 54. Once the lock pins 50 are in the release position, the carriage 40 can slide up or down on the tower portion 26 to a new vertical position, as desired, thereby adjusting the vertical position of the tether 44 relative to the tower portion 26. The second ends of the actuator bars 48 can be coupled to a common actuating element such as a lever or button via cables or the like (not shown). The common actuating element can be provided on the shroud 36 or base 20 in a location for convenient manipulating by a user.

A wide variety of release mechanisms can be employed without departing from the scope of the present disclosure. In some embodiments, such as the illustrated embodiment, the operative components of the release mechanism are associated with the carriage 40 and the passive components (e.g., holes 54) are associated with the tower portion 24. In other embodiments, the operative components can be supported on the tower portion or other adjacent structure and configured to engage passive components associated with the carriage. In still other embodiments, the carriage 40 and/or tower portion 26 can include a ratchet mechanism, a cam lock mechanism, or other similar arrangements for securing the carriage 40 relative to the tower portion 26. While two release mechanisms 46 are illustrated in the drawings as located on opposed sides of the carriage 40, one of skill in the art would readily understand that one or other numbers of release mechanisms could be utilized within the scope of the present disclosure, and that the release mechanisms 46 may be provided along a different location of the carriage 40, such as a front or rear side.

Also shown in FIG. 8 is an insert 58 received in the carriage 40. The insert 58 acts as a bushing between the carriage 40 and the tower portion 26. To this end, the insert 58 can be a plastic insert or other low friction material. In addition, the tether slot 42 is provided with a low friction insert 60 to prevent excessive wear on the tether 44. Certain low friction plastics such as polytetrafluoroethylene or the like may be especially suitable for the inserts 58 and 60.

It should now be appreciated that while the cam buckle 38 facilitates adjustment of the length of the free end of the tether 44, the length of the free end of the tether 44 can also be changed based on the position of the carriage 40 along the tower portion 26. For example, without adjusting the tether 44 with the cam buckle 38, the free end of the tether 44 will be relatively shorter when the carriage 40 is relatively lower on the tower portion 26 and relatively longer when the carriage 40 is relatively higher on the tower portion 26. This is because when the carriage 40 is relatively lower on the tower portion 26, the distance between the cam buckle 38 and the slot 42 is greater than when the carriage 40 is relatively higher on the tower portion 26. This feature can be useful when using the pet containment system 10 with animals of different sizes as the length of the free end of the tether 44 automatically increases as the carriage 40 is moved to a position consistent with use with a relatively larger animal and automatically decreases when the carriage 40 is moved to a position consistent with use with a relatively smaller animal. As such, adjustment of the length of the tether 44 using the cam buckle 38 may not be necessary thus simplifying use of the pet containment system 10.

Returning to FIGS. 1, 4 and 5, the features of the collapsible boom 16 will now be described. The collapsible boom 16 includes a generally loop-shape bar 64 supported on the tower portion 26 of the support frame 24. The bar 64 can have a shape generally corresponding to a shape of the base 20, but may have an overall footprint that is larger than a footprint of the base 20. The bar 64 can be a single member or assembled from multiple discrete sections that are assembled together to form the generally loop-shape. The bar 64 can be covered in a foam material or other cushioning-type material.

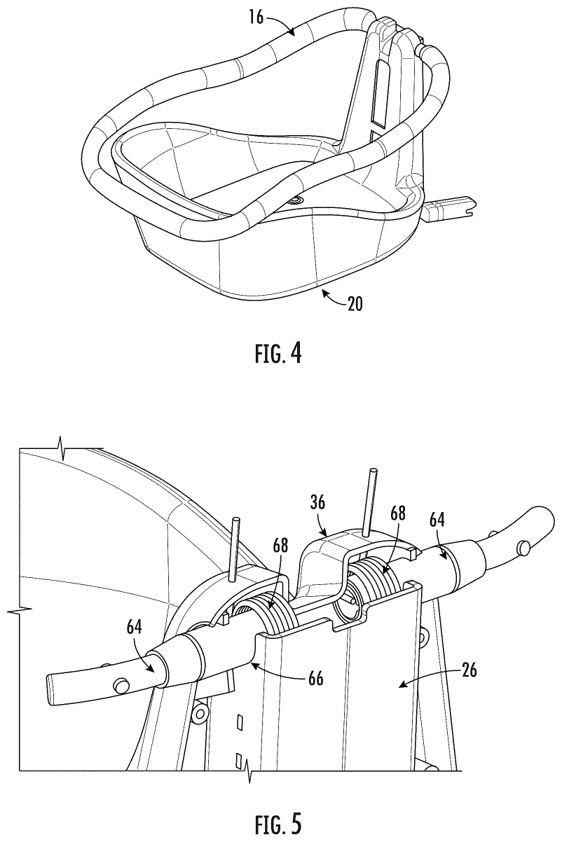

As best shown in FIG. 5, respective ends of the bar 64 are received in corresponding notches 66 of the tower portion 26 and secured by corresponding surfaces of the shroud 36. It will be appreciated that the ends of the bar 64 are rotatable relative to the tower portion 26 such that the boom 16 can be moved between an upper position shown in FIG. 1 and a lower position shown in FIG. 4, for example. In the position of FIG. 1, the flexible barrier 18 is held taught by the boom 16. In FIG. 4, the boom 16 is in a collapsed state (flexible barrier 18 not shown in FIG. 4) allowing easier access to an interior of the containment structure 12 for loading and/or securing a pet. The flexible barrier 18 can be, for example, a mesh fabric material or the like.

The collapsible boom 16 is biased towards the position shown in FIG. 1 by a pair of torsion springs 68. Each torsion spring 68 is interposed between an end of the bar 64 and the shroud 36 such that a rotational force is applied to the bar 64 that tends to bias the bar 64 towards the position shown in FIG. 1. The rotational force applied by the torsion spring 68 is generally sufficient to maintain the flexible barrier 18 in a taught condition, but can be easily overcome by a user pressing down on a front portion of the boom 16. Accordingly, the boom 16 can be pressed down to facilitate loading a pet into the containment structure 12 and then released to raise the flexible barrier 18 up into a use position. In some embodiments, the boom 16 can be locked in the use position such that a user activatable release (e.g., a button or the like) must be activated by a user to allow the boom 16 to be moved from the use position. In other embodiments, a detent mechanism can be provided that tends to resist movement of the boom 16 from the use position, but that may be overcome when sufficient force is applied to the boom 16 to overcome not only the biasing force of the torsion springs 68 but the additional resistance of the detent mechanism.

In some embodiments, the boom 16 and flexible barrier 18 can be easily changed out to provide a boom 16 and flexible barrier 18 of a different shape and/or size. For example, for a smaller pet a shorter flexible barrier 18 may be desired. In other instances, such as when the pet containment system 10 is installed in a compact car, a smaller boom may be desired. In still other instances, a user may choose to remove the boom and flexible barrier altogether.

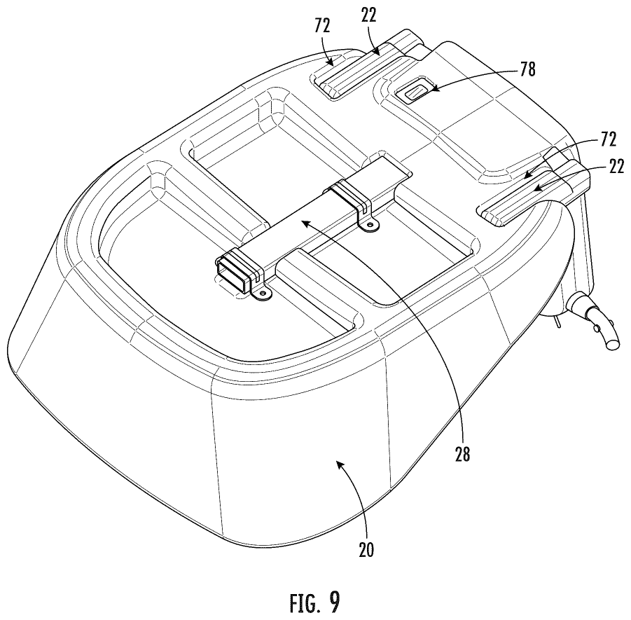

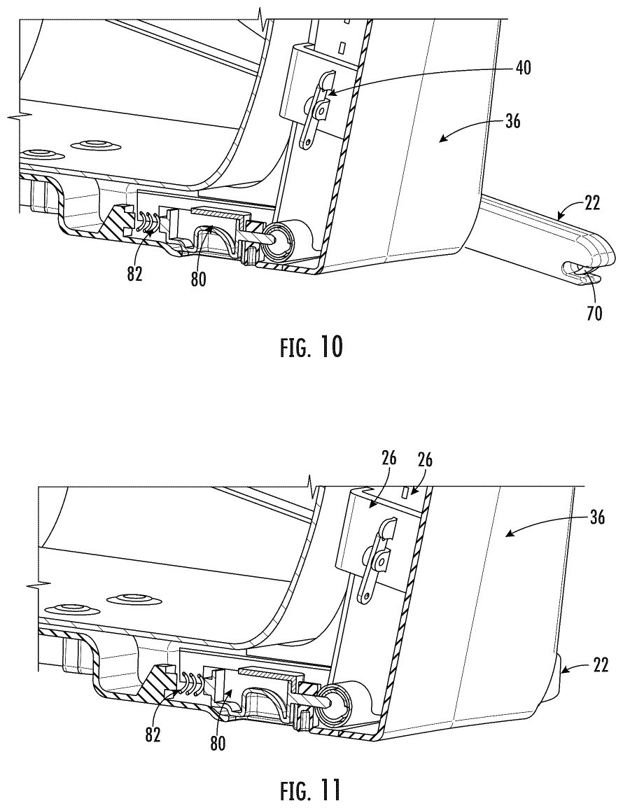

Turning now to FIGS. 9-12, the features of the latches 22 will be described. The latches 22 of the present embodiment are rigidly secured to the support frame 24 and rotatable between a stowed position (shown in FIGS. 9 and 11) and a deployed position (shown in FIG. 10). Each latch 22 includes a catch/hook 70 for releasably engaging a vehicle anchor (e.g., a LATCH anchor). The catch/hook 70 can retractably extend from a body of the housing of the latch 22. In the stowed position, the latches 22 are folded into latch pockets 72 in the bottom of the base 20. In an aspect, the latches 22 can be slidably connected to the support frame 24 such that the latches can translate between the stowed position and the deployed position. In the deployed position, the latches 22 protrude from a rear of the base 20 for connection to respective LATCH anchors of a vehicle (or other vehicle anchor point(s)). In some embodiments, the latches 22 can be adjustable in a horizontal direction to change a gap between the pet containment system 10 and a seatback of a vehicle.

Each latch 22 is supported on a rotating tubular cross-member, hereinafter referred to as latch tube 74. Latch tube 74 extends through a lower section of the tower portion 26 and is surrounded by a concentric outer fixed tube 76 extending from each side of the tower portion 26. The latch tube 74 is supported for rotation relative to the tower portion 26 to allow the latches 22 to rotate between the stowed and deployed positions. A latch lock 78 locks the latches 22 in either the stowed or deployed positions.

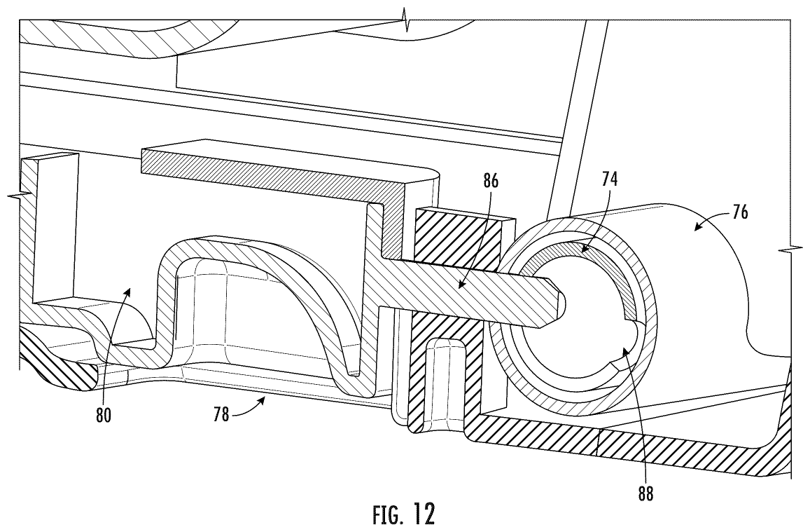

The latch lock 78 includes an actuator 80 supported for sliding movement in the base 20. The actuator 80 is movable between a locked position restricting rotation of the latch tube 74 and an unlocked position permitting rotation of the latch tube 74. A spring 82 biases the latch lock 78 towards the locked position. Movement of the actuator 80 to the left in FIG. 12 retracts a steel pin 86 from one of two holes 88 in the latch tube 74 allowing the latch tube 74 to rotate relative to the outer fixed tube 76. Upon positioning the latches 22 in either the stowed or deployed positions and release of the actuator 80, the spring 82 forces the pin 86 back into one of the holes 88 thereby restricting rotation of the latch tube 74 relative to the outer tube 76 and locking the latches 22 in position.

It should be appreciated that the latches 22, though rotatable relative to the tower portion 26 of the support frame 24, are rigidly secured to the support frame 24 and may be referred to as “rigid latches.” When locked in the deployed position, the latches 22 can be aligned with the lower LATCH anchors of a vehicle and pressed into latching engagement with the same. When deployed, the latches 22 extend a fixed distance from the containment system 10. In this manner, when installed in a vehicle and connected to vehicle anchor points, any relative movement between the containment system 10 and the vehicle seat is minimized or eliminated. Unlike assemblies wherein the latches are flexibly attached with straps or the like, the system of the present disclosure can more easily be positioned and secured within a vehicle, and does not require tightening of straps or other flexible components.

In other embodiments, the latches 22 can be retractable rather than rotatable. In such embodiments, each latch 22 can be supported for translating movement along a longitudinal axis of the latch between a stowed position and an extended position.

Various embodiments of the present disclosure can include a load leg 90 as shown in FIG. 1. The load leg 90 can be utilized to provide additional support and stability for installations, for example, in the case of large animals or pets or where the base 20 is not fully accommodated on the seat base of a vehicle.

In other embodiments, the latches 22 of the containment system 10 may be “soft latches.” In such embodiments, the at least one latch 22 is mounted to the containment system 10 using a flexible structure, such as one or more straps or pieces of webbing for example. Soft latch connectors may be substantially similar devices to rigid latch connectors discussed above, and in some embodiments may be tightened once attached to vehicle LATCH anchors. However, in other embodiments, the latch connectors may be various other types of clips and hooks, such as a carabiner or other clip, and may be biased toward a closed position and manually openable for attachment to vehicle anchors.

It should be noted that the illustrations and descriptions of the examples and embodiments shown in the figures are for exemplary purposes only, and should not be construed limiting the disclosure. One skilled in the art will appreciate that the present disclosure contemplates various embodiments. Additionally, it should be understood that the concepts described above with the above-described examples and embodiments may be employed alone or in combination with any of the other examples and embodiments described above. It should further be appreciated that the various alternative examples and embodiments described above with respect to one illustrated embodiment can apply to all examples and embodiments as described herein, unless otherwise indicated.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain examples have been described, these examples are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The words “inward,” “outward,” “upper,” and “lower” refer to directions toward or away from, respectively, the geometric center of the component.

It will be understood that reference herein to “a” or “one” to describe a feature such as a component or step does not foreclose additional features or multiples of the feature. For instance, reference to a device having, comprising, including, or defining “one” of a feature does not preclude the device from having, comprising, including, or defining more than one of the feature, as long as the device has, comprises, includes, or defines at least one of the feature. Similarly, reference herein to “one of” a plurality of features does not foreclose the invention from including two or more of the features. For instance, reference to a device having, comprising, including, or defining “one of a protrusion and a recess” does not foreclose the device from having both the protrusion and the recess.

What is claimed is:

1. An adjustable pet tether system for a vehicle comprising:
a base for receiving a pet;
a support frame secured to the base, the support frame being removably securable to the vehicle;
a carriage supported on the support frame for vertical movement along the support frame between a first lower position and a second upper position; and
a tether having a free end extending from the carriage;
wherein a vertical point of attachment of the tether relative to the support frame can be adjusted by moving the carriage along the support frame to a desired vertical height.

2. The adjustable pet tether system of claim 1, wherein the carriage is movable to at least one discrete position between the first lower position and the second upper position.

3. The adjustable pet tether system of claim 2, further comprising a release mechanism for selectively fixing the carriage to the support frame at the desired vertical height.

4. The adjustable pet tether system of claim 1, wherein the tether is secured to the support frame with an adjustment mechanism, whereby the adjustment mechanism allows adjustment of a length of the free end of the tether.

5. The adjustable pet tether system of claim 4, wherein the adjustment mechanism is a cam buckle.

6. The adjustable pet tether system of claim 1, further comprising at least one latch fixed to the support frame for securing the adjustable pet tether system to a cooperating anchor of the vehicle.

7. A pet containment system for a vehicle comprising:
a support frame mountable to the vehicle;
a containment structure secured to the support frame for receiving a pet; and
at least one latch rigidly fixed to the support frame for securing the pet containment system to a cooperating anchor of the vehicle.

8. The pet containment system of claim 7, wherein the at least one latch is movable between a deployed position and a stowed position.

9. The pet containment system of claim 8, further comprising a biasing member urging the at least one latch towards the deployed position.

10. The pet containment system of claim 9, further comprising a latch tube supported for rotation relative to the support frame, the at least one latch being supported on the latch tube for rotation between the deployed and stowed positions.

11. The pet containment system of claim 10, further comprising a latch lock for securing the at least one latch in at least one of the stowed and deployed positions.

12. The pet containment system of claim 11, wherein the latch lock includes an actuator coupled to a pin, and wherein the pin is selectively movable by the actuator into and out of a hole of the latch tube to restrict or permit rotation of the latch tube relative to the support frame.

13. The pet containment system of claim 7, further comprising a load leg for supporting the containment structure.

14. A pet containment system for a vehicle comprising:
a support frame including an upwardly extending tower portion and a horizontally extending base support portion;
at least one latch rigidly fixed to the support frame for securing the pet containment system to a cooperating anchor of the vehicle, the at least one latch movable between a stowed position and a deployed position;
a base secured to the base support portion of the support frame and extending outwardly from the tower portion of the support frame, the base defining at least a portion of a receptacle for receiving a pet;
a collapsible boom pivotally secured at one end to the tower portion of the support frame in spaced relation to the base, the boom extending over at least a portion of the base;
a flexible barrier extending between at least a portion of a perimeter of the base and the boom;
a carriage supported on the tower for movement between a first lower position and a second upper position, the carriage including a tether slot; and
an adjustable length tether secured to the tower portion of the support frame with a cam buckle for adjusting a length of a free end of the tether, the free end of the tether passing through the tether slot of the carriage;
whereby a vertical position of the free end of the tether can be adjusted by movement of the carriage between the first lower position and the second upper position; and
whereby a horizontal position of a terminal end of the free end of the tether can be adjusted with the cam buckle.

15. A pet containment system for a vehicle comprising:
a support frame including an upwardly extending tower portion and a horizontally extending base support portion;
a base secured to the support frame and extending outwardly from the tower portion of the support frame, the base defining at least a portion of a receptacle for receiving a pet;
a collapsible boom pivotally secured at one end to the tower portion of the support frame in spaced relation to the base, the boom extending over at least a portion of the base; and
a flexible barrier extending between at least a portion of a perimeter of the base and the boom;
wherein at least one of the support frame or the base is securable to a restraint system of a vehicle.

16. The pet containment system of claim 15, further comprising a biasing member for biasing the boom towards a use position.

17. The pet containment system of claim 15, wherein the boom is generally loop-shape.

18. The pet containment system of claim 15, wherein the boom is comprised of a plurality of discrete sections assembled together.

19. The pet containment system of claim 15, wherein the flexible barrier includes at least one of a fabric or a mesh.

20. The pet containment system of claim 15, further comprising at least one latch rigidly fixed to the support frame for securing the pet containment system to a cooperating anchor of the vehicle, the at least one latch movable between a stowed position and a deployed position.

21. The pet containment system of claim 15, further comprising a load leg for supporting the base.

22. A method of securing a pet to a pet containment system, the method comprising:
positioning a pet in a pet containment system having a base for receiving the pet, a support frame secured to the base, the support frame being removably securable to a vehicle, a carriage supported on the support frame for vertical movement along the support frame between a first lower position and a second upper position, and a tether having a free end extending from the carriage;
adjusting a vertical point of attachment of the tether relative to the support frame by moving the carriage along the support frame to a desired vertical height; and
securing the free end of the tether to a wearable component worn by the pet.

23. The method of claim 22, further comprising adjusting a length of the free end of the tether.

24. The method of claim 22, wherein positioning a pet in a pet containment system includes at least partially collapsing a collapsible boom pivotally secured at one end to a tower portion of the support frame in spaced relation to the base, the boom extending over at least a portion of the base and supporting a flexible barrier secured to the base.

25. A pet containment system for a vehicle comprising:
a base for receiving a pet;
a support frame secured to the base, the support frame being removably securable to the vehicle; and
a carriage supported on the support frame for vertical movement along the support frame between a first lower position and a second upper position, the carriage defining an attachment point for securing a pet;
wherein the carriage is movable to adjust a vertical height of the attachment point.

26. The pet containment system of claim 25, wherein the carriage is movable to at least one discrete position between the first lower position and the second upper position.

27. The pet containment system of claim 26, further comprising a release mechanism for selectively fixing the carriage to the support frame at a desired vertical height.

28. The pet containment system of claim 25, further comprising a tether having a free end extending from the carriage for attachment to a pet.

29. The pet containment system of claim 28, wherein a portion of the tether opposite the free end of the tether is fixed to the support frame such that movement of the carriage changes a length of the free end of the tether.

30. The pet containment system of claim 29, wherein the portion of the tether that is fixed to the support frame is secured to the support frame with an adjustment mechanism, whereby a length of a free end of the tether can be adjusted.

31. The pet containment system of claim 25, further comprising at least one latch fixed to the support frame for securing the pet containment system to a cooperating anchor of the vehicle.
